(19) United States
(12) Patent Application Publication
(10) Pub. No.: US 2004/0075527 A1
(43) Pub. Date: Apr. 22, 2004

(54) Ttemperature probe and a method for producing the same

(76) Inventors: Heinrich Zitzmann, Lauf an der Pegnitz (DE); Georg Bernitz, Nuernberg (DE)

Correspondence Address: Dougherty Clements & Hofer, The Roxborough Building, 1901Roxborough Road, Suite 300, Charlotte, NC, 20211, US

(21) Appl. No.: 10/240,081

(22) PCT Filed: Apr. 27, 2001
(86) PCT No.: PCT/EP01/04789

(30) Foreign Application Priority Data
Apr. 28, 2000 (DE) 100 20 932.7

(51) Int. Cl. H01C 3/04

(52) U.S. Cl. 338/28

(57) ABSTRACT

A temperature measurement sensing device formed of a substrate, a resistor layer, an oxide layer and a protective layer is produced by forming the structured resistor layer on a surface of the substrate, oxidizing the resistor layer formed and then applying the protective layer to at least a part of the resistor layer.

### BACKGROUND OF THE INVENTION

1. Field of the Invention

The present invention relates to a temperature measurement sensing device and to a method of manufacturing same.

2. Description of the Related Art

For many years, temperature measurement sensing devices have been produced in thin layer technology in different embodiments and used for precise temperature measurement tasks.

A known temperature measurement sensing device includes an Al₂O₃ ceramic substrate onto which a platinum film having a thickness of about 1 μm is applied. This platinum film is structured so as to have a resistor trace having a resistance of about 100 Ω. For the protection of the platinum resistor trace it is covered by a suitable protective layer. Connecting wires are welded thereto at two contact areas. In order to ensure a mechanical load of the connecting wires, a fixing glaze is applied to additionally fix the connecting wires mechanically. The fixing glaze is burnt in at temperatures of about 800° C. (the glaze has to melt) to provide a usage temperature of up to 600° C. (the glaze must not soften in this temperature range).

In the prior art, resistor temperature sensing devices having a normalized characteristic curve are known, the above-described platinum temperature sensing devices according to DIN EN 60751 being used most widely. Especially the cheap thin layer design described above has edged out the other metal sensing device types, such as, for example, temperature sensing devices having resistor layers of nickel, nickel alloys, copper, molybdenum, iridium, etc. Apart from the technical advantages of the platinum sensing devices, such as, for example, the extraordinary long-term stability, the very good chemical durability, the narrow tolerances, the wide temperature range of up to 600° C. or even up to 1000° C., these thin layer types have also become cheaper than temperature measurement sensing devices using non-noble metals.

However, there is still a demand for, for example, nickel sensing devices since in some applications the previously also normalized nickel characteristic curve (DIN 43760) has been naturalized and in spite of today's electronic capabilities sensing devices having the nickel characteristic curve continue to be demanded.

The nickel sensing devices available on the market, whether they are wire-wound or embodied in a thin layer, are practically all limited to temperatures of under 250° C., in most cases even considerably under 200° C.

A nickel thin layer temperature sensing device is usually constructed similarly to the platinum sensing device described above. A metal film of nickel is applied to a ceramic supporting substrate in a thin layer by sputtering, vapor deposition or the like. This metal film is then structured photochemically by a suitable method, resistor traces are etched free and then adjusted to the desired must resistance by means of laser ablation or similar methods.

Contrary to platinum sensing devices, the protective layers applied to the resistor layer for the metal film resistor are not made of glass but of a protective lacquer layer, for example made of silicone or similar materials. A glass cover applied by a screen-printing method, as is usual in platinum temperature measurement sensing devices, produces problems in the case of nickel since, in the burning-in process, the nickel would chemically react with the glass, which would result in the formation of bubbles in the glass (porosity) and in a change of the adjusted resistances.

In addition, the connecting wires are mostly either soldered or welded and fixed to the contact areas by means of an epoxy mass. Fixing by means of a glaze, as is usual in platinum sensing devices, is not possible in this case since the covering protective lacquer conventionally used does not endure the high burning-in temperature which is much higher than 400° C.

By these circumstances, the upper usage temperature is limited to the above-mentioned values of 200° C.

DE 198 30 821 A1 describes a temperature sensor element having an insulating substrate, a resistor metal film, connecting electrodes and connecting leads. The connecting leads are connected to the connecting electrodes and are mechanically fixed to the substrate by means of a fixing.

DE 25 389 66 A1 describes a method of manufacturing electric temperature sensing devices in which, onto a dielectric substrate, an electrically conductive metal oxide layer and onto this in turn a further metal layer is applied. The substrate includes terminals and a dielectric protective layer beyond which the terminals reach.

In the magazine Measurement Techniques, Vol. 39, No. 7, 1996, pp. 738 to 742, the effect of an oxidation of platinum on the characteristics of a standard platinum resistor thermometer is described.

DE 199 32 411 A1 describes a temperature sensor comprising a ceramic support onto which a resistor layer is applied. The outer surface of the resistor layer is covered by a diffusion barrier formed by an oxide layer.

### SUMMARY OF THE INVENTION

It is the object of the present invention to provide a method of manufacturing a temperature measurement sensing device and a temperature measurement sensing device, the resistor layer of which is formed by non-noble metals and which has a usage range over a wide range of temperatures.

The present invention is a method of manufacturing a temperature measurement sensing device, in which a structured resistor layer made of a non-noble metal is formed on a surface of a substrate, and the resistor layer formed is oxidized. A glaze layer at least partially covering the oxidized surface of the resistor layer is applied, and the glaze layer is burnt in.

Further, the present invention is a temperature measurement sensing device having a substrate, a resistor layer made of a non-noble metal formed on the substrate, the resistor layer being oxidized at the surface facing away from the substrate, and a burnt-in glaze layer at least partly covering the oxidized surface of the resistor layer.

In a preferred embodiment of the present invention, the resistor layer is made of nickel or a nickel alloy.

Preferably the protective layer applied to the resistor layer is a glass cover.

It is an advantage of the present invention that the inventive arrangement and the usage of the glass cover of the non-noble film, such as, for example, of the nickel film, and the glass fixing of the connecting wires even in the conventional usage range of 200° C. provide essential qualitative advantages, such as, for example, an improved protection against moisture by the glass cover or an improved thermal shock resistance of the glass fixing due to the adjusted thermal expansion coefficient of the glass regarding the ceramic.

It is a further advantage that, by the inventive arrangement, the usage range of the temperature measurement sensing device arrangements, such as, for example, for nickel sensing devices, can be extended up to over 300° C.

The present invention is based on the recognition that the glaze layer applied for the protection of the resistor layer does not react with the oxide layer when melting so that the problems occurring in the prior art are safely prevented. Thus it is prevented that inhomogeneities form at the interface between the resistor layer and the glaze, such as, for example, in the form of bubbles, whereby a safe application of the protective layer is achieved in spite of the cheap materials.

### BRIEF DESCRIPTION OF THE DRAWINGS

Preferred embodiments of the present invention will be subsequently detailed referring to the appended drawings, in which:

FIG. 1 shows a top view illustration of an inventive temperature measurement sensing device arrangement; and

FIG. 2 shows a cross-sectional illustration of the arrangement shown in FIG. 1.

### DESCRIPTION OF THE PREFERRED EMBODIMENTS

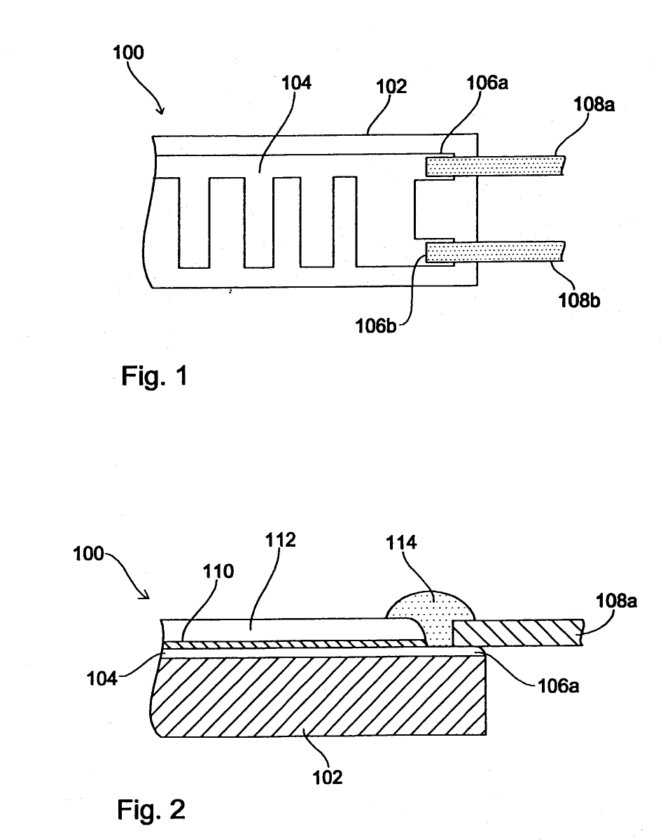

FIG. 1 shows a temperature measurement sensing device 100 including a substrate 102 onto which a structured resistor layer 104 is arranged. The resistor layer 104 further includes a first connection area 106a and a second connection area 106b. The connecting wires 108a and 108b are connected to the connection areas or contact pads 106a, 106b, respectively.

FIG. 2 shows a cross-sectional illustration of the temperature measurement sensing device 100 of FIG. 1. Equal elements are designated by the same reference numerals. As can be seen, an oxide layer 110 partly extending over the resistor layer is arranged on the resistor layer 104. The range in which a securing of the connecting wire 108a takes place is not covered by the oxide layer. The resistor layer 104 is covered by a glaze layer 112. The connecting wire 108a, additionally to its securing to the contact pad 106a, is mechanically fixed to the element by means of a fixing glaze 114.

According to the present invention, the bare resistor layer 104, which is, for example, a nickel film, must be protected so that the nickel film does not chemically react with the glaze layer 112 to be applied during the burning-in process. The glaze layer 112 is applied before the burning-in process by means of, for example, screen printing. The protection just mentioned is obtained by the fact that the surface of the nickel film is oxidized, i.e. the nickel film receives a dense nickel oxide layer (NiO) at the surface. This can, for example, be achieved by the fact that the resistor layer 104 applied to the substrate 102 is transferred to an oxide containing atmosphere at a higher temperature, such as, for example, 800° C., for a certain duration. By the oxidation, the original thickness of the electrically conductive nickel film is diminished since the forming NiO layer having a thickness of about 0.1 μm, from an electric point of view, is an insulator.

The advantage of the present invention, among other things, is that, by this pre-oxidation, the adjusted resistor values hardly change in the subsequent burning-in processes of the glaze layer 112 for the nickel film 104 or the fixing glaze 114 of the connecting wires 108a, 108b, respectively, taking place at about 800° C. The temperature measurement sensing devices 100 protected in this way are especially very stable up to relatively high usage temperatures of about 300° C.

Instead of the oxidation in an oxide containing atmosphere described above and at higher temperatures, this can also be achieved differently, such as, for example, by electrochemical means. In any case, the thickness of the oxide layer 110 can be controlled arbitrarily by the physical parameters of temperature, time, etc.

Apart from the pure nickel films described above, the inventive method can also be applied to nickel alloys, such as, for example, to nickel iron (Ni99, 4Fe or NiFe30). The alloy ratios just mentioned are not limited to fixed compositions. Regarding the connecting wires, various wire materials, such as, for example, nickel, silver, etc. can be used. Leadless sensing elements, such as, for example, SMD types, can also be produced in this way, i.e. with a glass cover of the film.

The fixing glaze 114 can be burnt in in a temperature range between 500° C. and 1000° C. The nickel film can be oxidized in a temperature range between 500° C. and 900° C. for a duration of a few minutes up to about 1 hour.

For securing the connecting wires at the contact pads 106a, 106b, after oxidizing the resistor layer, the oxide layer is removed in these areas and the connecting wires 108a and 108b are secured and, if required, fixed by a fixing glaze 114.

What is claimed is:

1. A method of manufacturing a temperature measurement sensing device, comprising the following steps:
(a) forming a structured resistor layer made of a non-noble metal on a surface of a substrate;
(b) oxidizing the resistor layer formed;
(c) applying a glaze layer at least partially covering the oxidized surface of the resistor layer; and
(d) burning in the glaze layer.

2. The method according to claim 1, wherein the non-noble metal is nickel or a nickel alloy.

3. The method according to claim 1, wherein the resistor layer includes at least one contact pad, the glaze layer being applied in such a way that the contact pad is exposed, the method comprising the following steps:
(e) removing the oxide layer from the contact pad; and
(f) securing a connecting wire at the contact pad.

4. The method according to claim 3, comprising the following step:
(g) fixing the connecting wire by means of a fixing glaze.

5. A temperature measurement sensing device comprising:
a substrate;
a resistor layer made of a non-noble metal formed on the substrate, the resistor layer being oxidized at the surface facing away from the substrate; and
a burnt-in glaze layer at least partly covering the oxidized surface of the resistor layer.

6. The temperature measurement sensing device according to claim 5, being connected to a contact pad and secured by a fixing glaze.
